(19) United States
(12) Patent Application Publication
(10) Pub. No.: US 2019/0042778 A1
(43) Pub. Date: Feb. 7, 2019

(54) Methods And Apparatus To Protect Digital Content With Computer-Mediated Reality

(71) Applicant: Intel Corporation, Santa Clara, CA (US)

(72) Inventors: Vadim A. Sukhomlinov, Santa Clara, CA (US); Tamir Damian Munafo, Naale (IL); Kshitij A. Doshi, Tempe, AZ (US)

(21) Appl. No.: 15/841,382

(22) Filed: Dec. 14, 2017

(51) Int. Cl. G06F 21/62; G06F 21/84; G06T 11/60

(52) U.S. Cl. CPC G06F 21/6218; G06T 11/60; G06F 21/84

(57) ABSTRACT

A data processing system includes technology for protecting digital content using computer-mediated reality (CMR). The system comprises a processor, first and second video ports, a non-transitory machine-readable medium, and a display protection module stored in the machine-readable medium. The display protection module enables the data processing system to (a) automatically determine whether at least part of an output screen from a presentation application should receive display protection; (b) in response to a determination that the output screen should not receive display protection, cause at least some content from the output screen to be sent to a primary display via the first video port; and (c) in response to a determination that at least part of the output screen should receive display protection, automatically cause at least some content from the output screen to be sent to a CMR headset via the second video port. Other embodiments are described and claimed.

### TECHNICAL FIELD

The present disclosure pertains in general to data processing systems and in particular to methods and apparatus for using computer-mediated reality to present digital content.

### BACKGROUND

In one scenario, a person on a business trip wants to work on the plane or in the airport. In particular, she wants to review sensitive or confidential data that is stored in her laptop computer. The laptop may include a liquid crystal display (LCD) monitor, and the laptop may use a conventional presentation application (e.g., a word processing application or a spreadsheet application) to present the confidential data on the monitor. However, conventional laptops are susceptible to spying, in that anyone who can see the monitor may be able to see the data presented on the monitor. Additionally, an unauthorized person may use a camera to perform unauthorized copying of the data that is being displayed.

In another scenario, a content provider wants to enable a customer to view digital video content such as a movie, but the content provider does not want the customer to be able to copy the content. A conventional data processing system (DPS) may use a conventional presentation application (e.g., a media player application) to present the video content on an LCD monitor or on a cathode ray tube (CRT) monitor. Also, the DPS may use one type of encryption to protect the content while it is stored in the DPS, and another type of encryption to protect the content while it is being transmitted to the monitor. However, with a conventional DPS, once the content is being presented on the monitor, it may be possible for the customer or another person to perform unauthorized copying of the content that is being displayed.

These and other scenarios involve a DPS with a conventional presentation application that is designed to present content on a display that is susceptible to spying and copying.

### BRIEF DESCRIPTION OF THE DRAWINGS

Features and advantages of the present invention will become apparent from the appended claims, the following detailed description of one or more example embodiments, and the corresponding figures, in which:

FIG. 1 is a block diagram of an example embodiment of a data processing environment which includes a data processing system that includes a display protection module.

FIG. 2 presents a flowchart of an example embodiment of a process for using computer-mediated reality to protect digital content.

FIG. 3 is a flow diagram illustrating an example embodiment of a process for using computer-mediated reality to protect digital content.

FIG. 4 is a flow diagram illustrating an example embodiment of a process for protecting digital content using computer-mediated reality in conjunction with other types of protection.

### DETAILED DESCRIPTION

As indicated above, when a conventional presentation application in a conventional DPS presents content on a monitor, that content may be susceptible to spying and copying. For instance, an unauthorized person may see the displayed content, and a camera may be used to copy the displayed content.

The present disclosure pertains to methods and apparatus that use computer-mediated reality (CMR) to protect digital content. In particular, as described in greater detail below, the present disclosure introduces a display protection module which intercepts video output that has been directed to a primary display and diverts some or all of that video output to a CMR headset. The CMR headset may be a virtual reality (VR) headset that allows the user to see only what is presented on the screen of the headset, or the CMR headset may be an augmented reality (AR) headset that allows the user to directly see the real world while the headset presents computer-generated information that is also visible to the user.

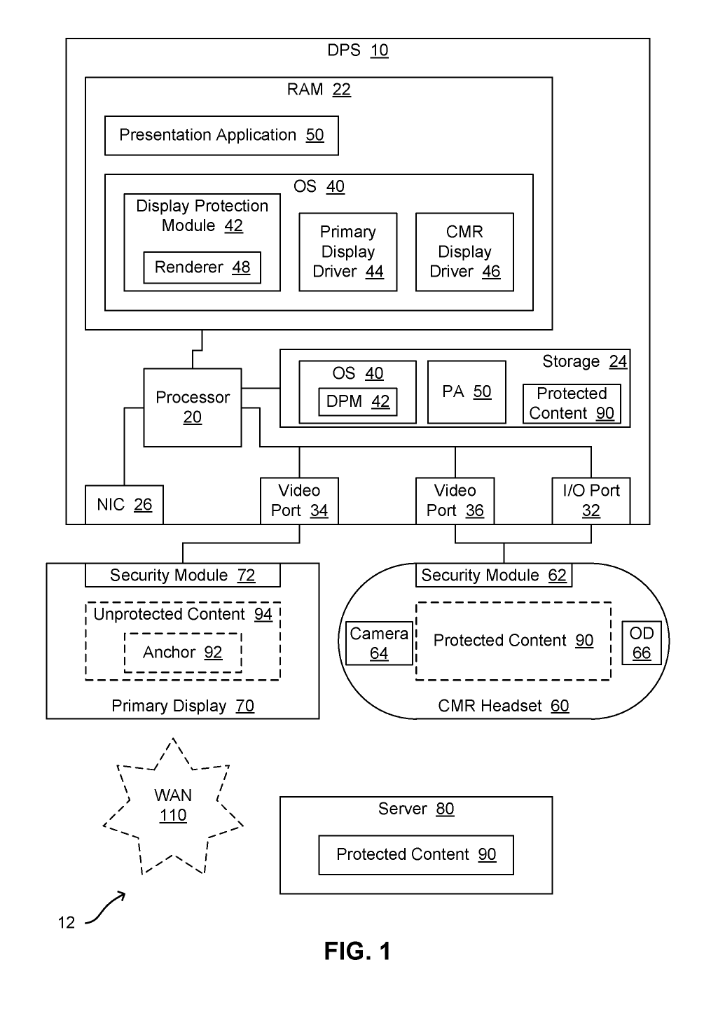

FIG. 1 is a block diagram of an example embodiment of a data processing environment 12 which includes a DPS 10 that includes a display protection module (DPM) 42. The hardware components of DPS 10 include a processor 20 communicatively coupled to various other components via one or more system buses. For instance, DPS 10 includes random access memory (RAM) 22, nonvolatile storage 24, a network interface controller (NIC) 26, an input/output (I/O) port 32, a video port 34, and a video port 36 responsive to processor 20. DPS 10 also includes a primary display 70 that is connected to DPS 10 via video port 34, as well as a CMR headset 60 that is connected to DPS 10 via video port 36 and I/O port 32. Any suitable technology or combination of technologies may be used to implement I/O port 32. For instance, I/O port 32 may use a universal serial bus (USB) protocol or any other suitable wired protocol. In addition or alternatively, I/O port 32 may use one or more wireless protocols, including without limitation protocols referred to under names or trademarks like WI-FI, BLUETOOTH, etc.

In the embodiment of FIG. 1, CMR headset 60 includes a security module 62, a camera 64, and an orientation detector (OD) 66. As described in greater detail below, DPM 42 may receive input from camera 64 and orientation detector 66 via I/O port 32, and DPM 42 may use that input data to determine a current position and orientation of CMR headset 60, relative to primary display 70. For instance, DPM 42 may use that input data to determine how far CMR headset 60 is from primary display 70 and to determine whether primary display 70 is in the line of sight of the user. And if primary display 70 is in the line of sight, DPM 42 may use that input data to determine where one or more display objects on primary display 70 are situated within that line of sight.

Security module 62 enables CMR headset 60 to decrypt video output that has been encrypted using the High-bandwidth Digital Content Protection (HDCP) protocol or any other suitable protocol for protecting video transmissions. Primary display 70 may also include a security module 72 which serves the same purpose for primary display 70.

Primary display 70 is a conventional monitor with a screen size that is large enough to present information that will be legible to a user whose eyes are over six inches away from the surface of the screen. Accordingly, primary display 70 may be an LCD or CRT monitor with a screen size of at least 50 square inches.

By contrast, CMR headset 60 is designed to be worn on the head of the user and to present information on a display surface that is less than six inches away from the eyes of the user. For instance, CMR headset 60 may be a VR headset or an AR headset. Accordingly, CMR headset 60 may be implemented, for example, as so-called “smartglasses” which provide a heads-up display. In other words, CMR headset 60 may include an optical projection system that includes at least one lens which is positioned in front of at least one of the user's eyes, with the lens serving as a transparent display which reflects projected digital images while allowing the user to see through the lens.

In DPS 10, storage 24 includes various software components, such as an operating system (OS) 40 and a presentation application (PA) 50. In the embodiment of FIG. 1, DPM 42 is implemented as part of OS 40. In addition, OS 40 includes a primary display driver 44 for sending video output to primary display 70 and a CMR display driver 46 for sending video output to CMR headset 60. PA 50 may be a media player application, a word processor application, a spreadsheet application, an email application, a web browser application, or any other suitable type of presentation application. Processor 20 may copy software components into RAM 22 for execution. Accordingly, in FIG. 1, OS 40 and presentation application 50 are depicted in storage 24 and in RAM 22.

As described in greater detail below, DPM 42 protects digital content by analyzing video output that presentation application 50 has directed to primary display 70 and by diverting at least some of that video output to CMR headset 60. By preventing DPS 10 from presenting the diverted output on primary display 70, DPM 42 makes it impossible or impractical for an unauthorized person to see the diverted output, and DPM 42 makes it difficult or impossible for anyone to copy the diverted output.

As illustrated, data processing environment 12 may also include a server 80, as well as one or more networks which enable the DPS 10 and server 80 to communicate with each other. Those networks may include, for instance, a wide area network (WAN) 110, a local area network (LAN), a personal area network (PAN), a mesh network, or any other suitable type of network or combination of networks. Server 80 may include the same components or similar kinds of components as DPS 10. For instance, server 80 may include at least one processor, RAM, nonvolatile storage, and a NIC. In the embodiment of FIG. 1, server 80 includes protected content 90. In one scenario, DPS 10 obtains protected content 90 from server 80 and then stores protected content 90 in storage 24. In other scenarios, protected content 90 may be created by the user of DPS 10 or obtained from another source.

The user of DPS 10 may use presentation application 50 to view protected content 90. However, as described in greater detail below, when presentation application 50 generates video output based on protected content 90, DPM 42 intercepts protected content 90 and diverts it to CMR headset 60. In addition, as described in greater detail below, some of the video output that is generated by presentation application 50 may be considered to be unprotected content 94. For instance, presentation application 50 may output protected content 90 as the main body of an application screen that also includes a window frame, menu bars, and other display objects. DPM 42 may consider the window frame, menu bars, and similar display objects from presentation application 50 to be unprotected content 94, while considering the main body of the window as protected content 90. In addition, DPM 42 may allow presentation application 50 to send unprotected content 94 to primary display 70.

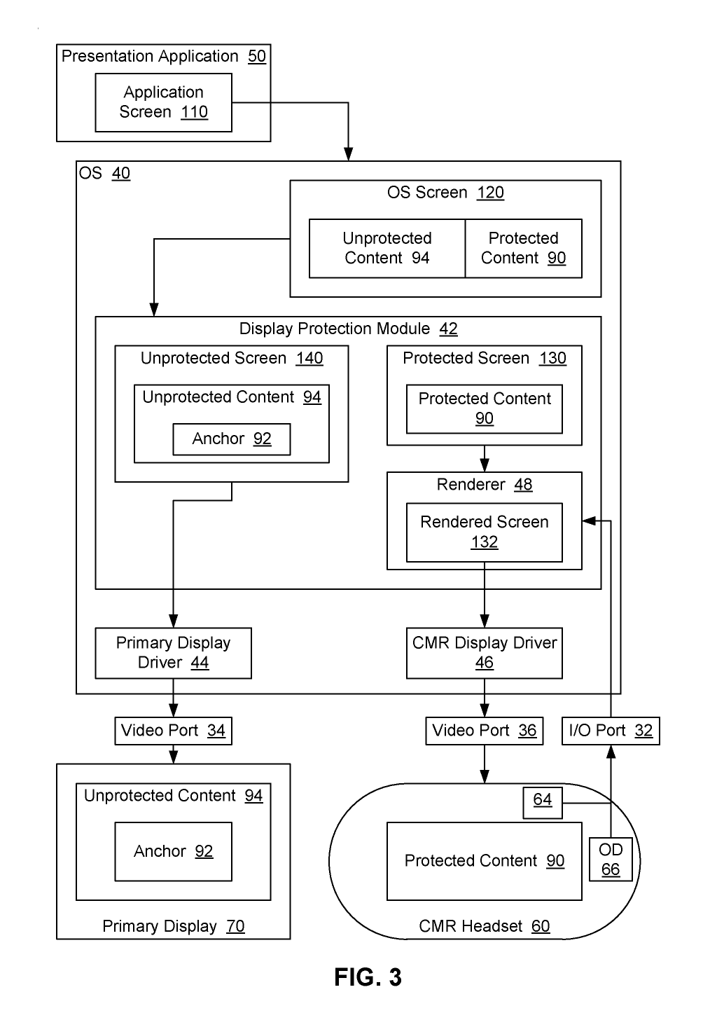

Also, DPM 42 may send an anchor 92 to primary display 70, and DPM 42 may use camera 64, OD 66, and anchor 92 to determine how protected content 90 should be displayed by CMR headset 60. For instance, as illustrated in FIG. 3 and described in greater detail below, DPM 42 may include a renderer 48 which adjusts the position and apparent perspective of protected content 90 within CMR headset 60 to keep protected content 90 in a line of sight that makes protected content 90 appear to the user as if it were being displayed on primary display 70. DPM 42 may use a quick response (QR) code or any other suitable display object as anchor 42. In one embodiment or scenario, DPM 42 obtains anchor 42 from presentation application 50.

In another embodiment or scenario, DPM 42 uses another part of the unprotected content in primary display 70 as the anchor. For instance, DPM 42 may use some or all of the overall window frame for presentation application 50 as the anchor. In another embodiment or scenario, instead of using a graphical item from primary display 70 as the anchor, DPM 42 may use one or more specific physical features of primary display 70 as the anchor. For instance, DPM 42 may use the four corners of primary display 70 as the anchor.

In another embodiment or scenario, the DPM may use some other physical object in front of the user as the anchor. For instance, the DPM may allow the user to utilize a CMR headset to work with a closed laptop as the host device to execute the presentation application and the DPM, and the DPM may generate a virtual laptop screen in the CMR headset that makes it looks, to the user, like the laptop is open and like data is being presented on the virtual laptop screen. In addition or alternatively, the DPM may generate a virtual screen that appears to be independent, and the DPM may present data on that virtual screen. In addition, the DPM may display virtual input devices (such as a keyboard and a mouse), and the DPM may use the camera of the CMR headset to detect whether or not the user is interacting with those virtual input devices. Accordingly, the DPM may generate user input for the presentation application, based on user interactions with the virtual input devices. Similarly, the DPM may treat the virtual screen as a touch screen, using the camera of the CMR headset to determine when and where the user has touched the virtual screen.

In another embodiment, the DPM and one or more presentation applications may execute on a smartphone, the user may use the smartphone as the keyboard, the DPM may generate an independent virtual screen that contains some or all of the content from the presentation applications, and the DPM may use the smartphone as the anchor. In another embodiment or scenario, the DPM may execute on a host device that is not visible to the user, and the DPM may use any suitable physical object in front of the user as the anchor. For instance, a user on a plane may be wearing a CMR headset that is wirelessly connected to a host device that is contained within a briefcase, and the user may use the CMR headset to launch a presentation application on the host device without touching the host device. In response, the DPM in the host device may use the camera of CMR headset detect a suitable physical object in front the user (e.g., the back of the seat in front of the user, or the tray table, or a smartphone resting on the tray table), and the DPM may use that object as the anchor. The DPM may then generate a virtual screen and virtual input devices for the user to utilize, as indicated above.

Referring again to the embodiment, of FIG. 1, protected content 90 is illustrated with dashed lines in CMR headset 60 to indicate that protected content 90 is being displayed by CMR headset 60. Similarly, unprotected content 94 and anchor 92 are illustrated with dashed lines in primary display 70 to indicate that those items are being displayed by primary display 70.

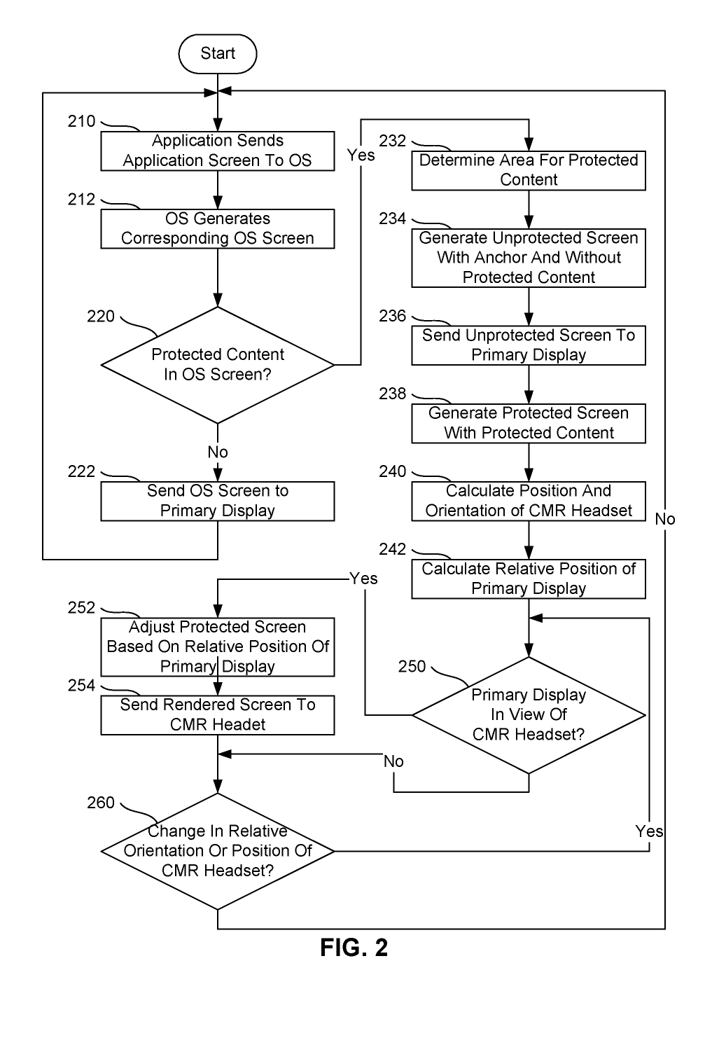

FIG. 2 presents a flowchart of an example embodiment of a process for using CMR to protect digital content, and FIG. 3 is a corresponding flow diagram. The process of FIG. 2 begins with presentation application 50 generating video output. For purposes of this disclosure, the video output that is generated by presentation application 50 may be referred to as an “application screen.” An application screen may include multiple different display objects. For instance, as indicated above, the application screen may include a main body that contains protected content 90, and the application screen may also include other display objects produced by presentation application 50, such as a window frame, menu bars, etc. In FIG. 3, the application screen that is generated by presentation application 50 is depicted as application screen 110. In one embodiment, OS 40 provides a graphics application programming interface (API), and presentation application 50 uses that graphics API to send application screen 110 to OS 40. Accordingly, FIG. 2 starts at block 210 with presentation application 50 sending application screen 110 to OS 40.

As shown at block 212, when presentation application 50 generates application screen 110 and sends application screen 110 to OS 40, OS 40 responds by generating a corresponding OS screen. For purposes of this disclosure, the video output that OS 40 generates based on the application screen may be referred to as the “OS screen.” For instance, OS 40 may contain a window manager that converts application screens into OS screens. In particular, the OS screen may include the objects from the application screen, and the window manager may give each of those objects a specific size and position within the OS screen. For instance, the window manager may generate an overall window for presentation application 50, and the window manager may automatically adjust the size and position of each of the display objects from presentation application 50 within that overall window, based on the current size of the overall window. In FIG. 3, the OS screen that is generated by OS 40 is depicted as OS screen 120.

As illustrated, OS screen 120 may include both protected content 90 and unprotect content 94. In addition, OS 40 may direct OS screen 120 to primary display 70. For instance, when configuring the objects within OS screen 120, OS 40 may operate as if OS screen 120 is to be displayed on primary display 70.

As shown at block 220, DPM 42 may then automatically determine whether OS screen 120 includes any protected content. In one scenario or embodiment, DPM 42 makes that determination based on data from presentation application 50 which indicates that the main body of application screen 110 includes protected content 90. For instance, presentation application 50 may provide an option that can be selected by a user to turn on CMR protection on demand. And when that option has been selected, presentation application 50 may use the graphics API of OS 40 to notify DPM 42 that CMR protection is to be used. Moreover, presentation application 50 may indicate that CMR protection is to be applied to all of the video output from presentation application 50, or presentation application 50 may indicate that CMR protection is to be applied to a particular portion of that video output, such as the main body of application screen 110. In addition or alternatively, protected content 90 may reside in a file that is flagged with an attribute that causes OS 40 to use CMR protection whenever any presentation application is attempting to display the content of that file. In addition or alternatively, DPM 42 may be configured to use CMR protection for one or more particular applications. In addition or alternatively, DPM 42 may be configured to use CMR protection for one or more particular types of files. In addition or alternatively, other mechanisms may be used to cause the OS to use CMR protection for protected content.

As shown at block 222, if OS 40 determines that the OS screen does not contain any protected content, OS 40 may send the complete OS screen to primary display 70. For instance, OS 40 may use primary display driver 44 to direct the OS screen to primary display 70 via video port 34. The process may then return to block 210, and presentation application 50 may then accept user input and modify the application screen accordingly.

However, if DPM 42 determines at block 220 that the OS screen does include protected content (as is the case for OS screen 120 in FIG. 3), DPM 42 may then determine the area within the OS screen that includes the protected content, as shown at block 232. As shown at block 234, DPM 42 may then generate an unprotected screen 140 that includes any unprotected content from the OS screen, but that omits the protected content. Accordingly, FIG. 3 depicts unprotected screen 140 as containing unprotected content 94 but not protected content 90. In effect, DPM 42 may thus remove protected content from the OS screen for presentation application 50. Also, in place of protected content 90, DPM 42 may add anchor 92 to the unprotected screen. As described below, DPM 42 may subsequently use anchor 92 to coordinate the information that is displayed in CMR headset 60 with the information that is displayed on primary display 70.

As shown at block 236, after generating unprotected screen 140, DPM 42 may send unprotected screen 140 to primary display 70. For instance, OS 40 may use primary display driver 44 to direct unprotected screen 140 to primary display 70 via video port 34.

In addition, as shown at block 238, DPM 42 may generate a protected screen 130 that contains the protected content that was removed from the OS screen. Accordingly, FIG. 3 depicts protected content 90 in protected screen 130.

As shown at blocks 240 and 242, DPM 42 may then use the orientation data and the vision data from CMR headset 60 to calculate the current position and orientation of CMR headset 60 and to calculate the current position of primary display 70, relative to the current position and orientation of CMR headset 60.

In particular, as illustrated in FIG. 3, camera 64 and orientation detector 66 may send data to OS 40 via I/O port 32, and renderer 48 may use that data to monitor the position and orientation of CMR headset 60, relative to anchor 92. For example, the data from CMR headset 60 may include a picture of anchor 92 from camera 64, as well as orientation data from orientation detector 66. Renderer 48 may use the data from CMR headset 60 to determine a current point of view and line of sight for the user. Additionally, as described in greater detail below, renderer 48 may use the data from CMR headset 60 to determine where the protected content should be positioned and how the protected content should be sized (e.g., stretched and skewed) in CMR headset 60, in order to make the protected content appear (a) in line with the main body of the unprotected screen within the window frame for presentation application 50 and (b) with dimensions (including starching and skewing) that make the content appear as if it is being displayed by primary display 70.

Referring again to FIG. 2, as shown at block 250, DPM 42 may then determine whether primary display 70 is in the field of view of CMR headset 60. If primary display 70 is not in the current field of view, the process may proceed to block 260, and DPM 42 may wait until primary display 70 is in the current field of view before sending protected content 90 to CMR headset 60, as described in greater detail below.

However, as shown at block 252, if primary display 70 is in the current field of view, DPM 42 may adjust the protected screen, based on the position of primary display 70 relative to the current field of view of CMR headset 60. For instance, as shown in FIG. 3, DPM 42 may use renderer 48 to generate a rendered screen 132 for protected content 90, based on protected screen 130, and based on the position of primary display 70, relative to the current field of view of CMR headset 60. In particular, when generating rendered screen 132, renderer 48 may adjust the position of the content that is included, and renderer 48 may stretch and skew that content, based on the position of primary display 70, relative to the current field of view of CMR headset 60.

As shown at block 254, renderer 48 may then send rendered screen 132 to CMR headset 60. For instance, renderer 48 may use CMR display driver 46 to direct rendered screen 132 to CMR headset 60 via video port 36. And since rendered screen 132 is being presented in a manner that prevents unauthorized people from seeing it, rendered screen 132 may also be referred to as a protected screen or a secure screen.

In one embodiment, CMR display driver 46 includes VR software or mixed-reality software that provides an API for manipulating and using virtual surfaces to be presented by CMR headset 60. Renderer 48 may use that API to create a virtual surface that is aligned with primary display 70 and renderer 48 may use that API to specify the data to be displayed on that surface. Accordingly, that virtual surface may serve as rendered screen 132.

In addition, renderer 48 may generate and use calibration parameters to customize rendered screen 132 to counteract any optical complications. For instance, if CMR headset 60 is using corrective lenses, renderer 48 may use calibration parameters to adjust rendered screen 132 so the rendered screen 132 does not look distorted to the user.

Also, as shown at block 260, DPM 42 may continue to monitor the position and orientation of CMR headset 60, relative to anchor 92. And if the relative position or orientation changes, DPM 42 may automatically adjust the position and size of the protected content, to keep the protected content aligned with and sized for the main body of the unprotected screen (or to add the protected content to the view, if the orientation of CMR headset 60 has just changed to include primary display 70) as the user's point of view and line of sight changes, as shown at blocks 250, 252, and 254.

As indicated by the arrow returning to block 210 from block 260, presentation application 50 may also continue to accept user input and modify the application screen accordingly. For instance, the user may scroll from a first page of protected content to a second page, and in response, presentation application 50 may adjust the contents of application screen 110 accordingly. Consequently, DPM 42 may use the process described above to automatically causing the second page of protected content to be displayed in the CMR headset in place of the first page of protected content.

Thus, as has been described, the video output from presentation application 50 and OS 40 takes different forms at different times, until the final form for that video output eventually appears on either primary display 70 or in CMR headset 60. For purposes of this disclosure, the visually perceptible image that actually appears on a display device may be referred to as a “physical screen,” while a screen which contains an internal digital representation of video output may be referred to as an “internal screen.” Thus, as depicted in FIG. 3, application screen 110, OS screen 120, unprotected screen 140, protected screen 130, and rendered screen 132 are all internal screens.

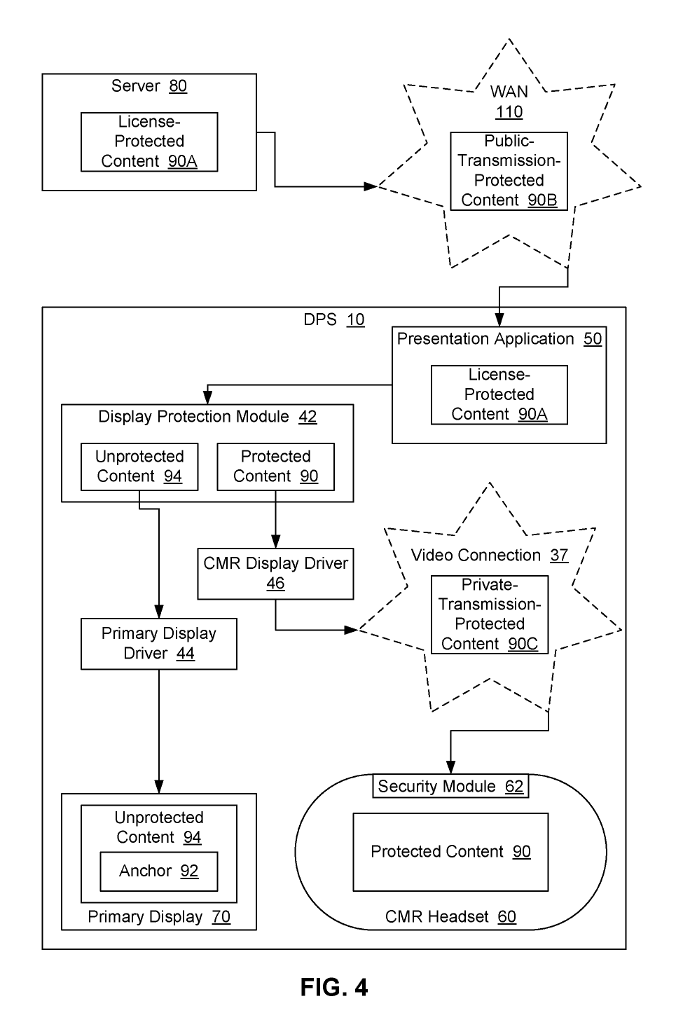

FIG. 4 is a flow diagram illustrating an example embodiment of a process for protecting digital content using computer-mediated reality in conjunction with other types of protection. In the embodiment of FIG. 4, server 80 contains a file that is protected according to a particular digital rights management (DRM) protocol. For instance, the file may contain a video that is protected with DRM protocol which require DPS 10 to have a particular type of license before DPS 10 is allowed to play the video. For instance, the file may include an encrypted version of the video, and the DRM protocol may require DPS 10 to have a particular type of license before DPS 10 is allowed to decrypt the video. Accordingly, that file is depicted as license-protected content 90A.

In addition, another type of encryption may be used to protect the file while DPS 10 is downloading the file is downloaded from server 80. For instance, DPS 10 and server 80 may use a secure network protocol such as Hypertext Transfer Protocol (HTTP) over Transport Layer Security (TLS) (HTTPS) to transfer the file. Accordingly, the file is depicted within WAN 110 as public-transmission-protected content 90B.

If DPS 10 has an appropriate license, presentation application 50 may decrypt the content in license-protected content 90A. The decrypted content is illustrated in FIG. 4 as protected content 90.

However, DPS 10 may use another type of encryption to protect the content when it is being sent to a display device. For example, as illustrated in FIG. 4, DPM 42 may use a secure video transmission protocol to protect the content while it is in transit to CMR headset 60. For example, DPM 42 may use the HDCP protocol to protect video transmissions to CMR headset 60. In FIG. 4, the path from CMR display driver 46 to CMR headset 60 through video port 36 and security module 62 is illustrated as video connection 37, and the protected content within video connection 37 is illustrated as private-transmission-protected content 90C. When CMR headset 60 receives the content, security module 62 may decrypt the content to enable display of the content by CMR headset 60. Accordingly, the decrypted content is illustrated in CMR headset 60 in FIG. 4 as protected content 90.

Thus, digital content that is protected by DRM technology may be (a) stored in a first protected form, (b) transmitted in a second protected form from one DPS to another, and (c) transmitted in a third protected form from one component of a DPS to another component of that same DPS. However, with a conventional DPS, once the content is being presented on a monitor, it may be possible to perform unauthorized copying of the content. By contrast, a DPM according to the present disclosure intercepts protected content that has been directed to a primary display and diverts that video output to a CMR headset. The DPM thereby makes it impossible or impractical for an unauthorized person to see the diverted output, and the DPM makes it impossible or impractical for anyone to copy the diverted output.

As has been described, a DPM may protect a portion of a screen generated by a presentation application by diverting that portion from a primary display to a CMR headset. In addition or alternatively, the DPM may be configured to protect all of the video output from a presentation application by diverting all of that output from a primary display to a CMR headset. In addition or alternatively, a presentation application may provide the user with a selectable CMR-protection option to enable the user to turn on CMR protection for the application. In addition or alternatively, a DPM may be configured to provide CMR protection for all files of a particular type. For instance, the DPM may include a protection policy that identifies particular applications and particular files types that are to be handled with CMR protection. In addition or alternatively, a DPM may be configured to provide for multiple so-called “virtual desktops,” and the DPM may be configured to provide protection for all applications within one or more of those virtual desktops.

Also, as indicated above, a renderer may be implemented as part of the DPM. However, in other embodiments, the render may be implemented as part of another component (e.g., as part of the CMR display driver) or as an independent software module which is connected to both the CMR display driver and the DPM through trusted channels, with the renderer receiving orientation data and image data from the CMR headset for proper embedding of application content. The orientation data may describe a current orientation of the headset, as well as a current position of the headset relative to an anchor or any other suitable reference location. In addition or alternatively, a DPM may generate position data for a headset, based on image data from a camera of the headset.

Additionally, although certain example embodiments are described herein, one of ordinary skill in the art will understand that those example embodiments may easily be divided, combined, or otherwise altered to implement additional embodiments. Likewise, expressions such as “an embodiment,” “one embodiment,” and “another embodiment” are meant to generally reference embodiment possibilities. Those expressions are not intended to limit the invention to particular embodiment configurations. As used herein, those expressions may reference the same embodiment or different embodiments, and those embodiments are combinable into other embodiments. In light of the principles and example embodiments described and illustrated herein, it will be recognized that the illustrated embodiments can be modified in arrangement and detail without departing from such principles.

As described above, a device may include instructions and other data which, when accessed by a processor, cause the device to perform particular operations. For purposes of this disclosure, instructions which cause a device to perform operations may be referred to in general as “software.” Software and the like may also be referred to as “control logic.” Software that is used during a boot process may be referred to as “firmware,” as may software that is stored in nonvolatile memory.

Software may be organized using any suitable structure or combination of structures. Accordingly, terms like “program” and “module” may be used in general to cover a broad range of software constructs, including without limitation application programs, subprograms, routines, functions, procedures, drivers, libraries, data structures, processes, microcode, and other types of software components. Also, it should be understood that a software module may include more than one component, and those components may cooperate to complete the operations of the module. Also, the operations which the software causes a device to perform may include creating an operating context, instantiating a particular data structure, etc. Any suitable operating environment and programming language (or combination of operating environments and programming languages) may be used to implement software components described herein.

A medium which contains data and which allows another component to obtain that data may be referred to as a “machine-accessible medium” or a “machine-readable medium.” In one embodiment, software for multiple components is stored in one machine-readable medium. In other embodiments, two or more machine-readable media may be used to store the software for one or more components. For instance, instructions for one component may be stored in one medium, and instructions another component may be stored in another medium. Or a portion of the instructions for one component may be stored in one medium, and the rest of the instructions for that component (as well instructions for other components), may be stored in one or more other media. Similarly, software that is described above as residing on a particular device in one embodiment may, in other embodiments, reside on one or more other devices. For instance, in a distributed environment, some software may be stored locally, and some may be stored remotely. Similarly, operations that are described above as being performed on one particular device in one embodiment may, in other embodiments, be performed by one or more other devices.

Accordingly, alternative embodiments include machine-readable media containing instructions for performing the operations described herein. Such media may be referred to as program products. Such media may include, without limitation, tangible non-transitory storage components such as magnetic disks, optical disks, RAM, read-only memory (ROM), etc., as well as processors, controllers, and other components that include data storage facilities. For purposes of this disclosure, the term “ROM” may be used in general to refer to nonvolatile memory devices such as erasable programmable ROM (EPROM), electrically erasable programmable ROM (EEPROM), flash ROM, flash memory, etc.

It should also be understood that the hardware and software components depicted herein represent functional elements that are reasonably self-contained so that each can be designed, constructed, or updated substantially independently of the others. In alternative embodiments, many of the components may be implemented as hardware, software, or combinations of hardware and software for providing the functionality described and illustrated herein. In some embodiments, some or all of the control logic for implementing the described operations may be implemented in hardware logic (e.g., as part of an integrated circuit chip, a programmable gate array (PGA), an application-specific integrated circuit (ASIC), etc.).

The present teachings may be used to advantage in many different kinds of data processing systems. Example data processing systems may include, without limitation, accelerators, systems on a chip (SOCs), wearable devices, handheld devices, smartphones, telephones, entertainment devices such as audio devices, video devices, audio/video devices (e.g., televisions and set-top boxes), vehicular processing systems, personal digital assistants (PDAs), tablet computers, laptop computers, portable computers, personal computers (PCs), workstations, servers, client-server systems, distributed computing systems, supercomputers, high-performance computing systems, computing clusters, mainframe computers, mini-computers, and other devices for processing or transmitting information. Accordingly, unless explicitly specified otherwise or required by the context, references to any particular type of data processing system (e.g., a PC) should be understood as encompassing other types of data processing systems, as well. Also, unless expressly specified otherwise, components that are described as being coupled to each other, in communication with each other, responsive to each other, or the like need not be in continuous communication with each other and need not be directly coupled to each other. Likewise, when one component is described as receiving data from or sending data to another component, that data may be sent or received through one or more intermediate components, unless expressly specified otherwise. In addition, some components of the data processing system may be implemented as adapter cards with interfaces (e.g., a connector) for communicating with a bus. Alternatively, devices or components may be implemented as embedded controllers, using components such as programmable or non-programmable logic devices or arrays, ASICs, embedded computers, smart cards, and the like. For purposes of this disclosure, the term “bus” includes pathways that may be shared by more than two devices, as well as point-to-point pathways. Also, for purpose of this disclosure, the term “processor” denotes a hardware component that is capable of executing software. For instance, a processor may be implemented as a central processing unit (CPU), a processing core, or as any other suitable type of processing element. A CPU may include one or more processing cores, and a device may include one or more CPUs.

Also, although one or more example processes have been described with regard to particular operations performed in a particular sequence, numerous modifications could be applied to those processes to derive numerous alternative embodiments of the present invention. For example, alternative embodiments may include processes that use fewer than all of the disclosed operations, process that use additional operations, and processes in which the individual operations disclosed herein are combined, subdivided, rearranged, or otherwise altered.

In view of the wide variety of useful permutations that may be readily derived from the example embodiments described herein, this detailed description is intended to be illustrative only, and should not be taken as limiting the scope of coverage.

The following examples pertain to further embodiments.

Example A1 is a data processing system with technology for protecting digital content using CMR. The data processing system comprises a processor, first and second video ports responsive to the processor, a non-transitory machine-readable medium responsive to the processor, and a display protection module stored in the machine-readable medium. When executed by the data processing system, the display protection module enables the data processing system to perform operations comprising (a) automatically determining whether at least part of an output screen from a presentation application should receive display protection; (b) in response to a determination that the output screen should not receive display protection, causing at least some content from the output screen to be sent to a primary display via the first video port; and (c) in response to a determination that at least part of the output screen should receive display protection, automatically causing at least some content from the output screen to be sent to a CMR headset via the second video port.

Example A2 is a data processing system according to Example 1, wherein the operation of automatically causing at least some content from the output screen to be sent to the CMR headset comprises (a) generating a rendered screen which includes content that has been adjusted to align with the primary display from a perspective of a person wearing the CMR headset; and (b) sending the rendered screen to the CMR headset.

Example A3 is a data processing system according to Example A2, wherein the operation of generating the rendered screen comprises automatically using an anchor displayed on the primary display to determine the perspective of the person wearing the CMR headset.

Example A4 is a data processing system according to Example A3, wherein the display protection module, when executed by the data processing system, enables the data processing system to perform further operations comprising (a) automatically adding the anchor to an unprotected screen, and (b) sending the unprotected screen to the primary display.

Example A5 is a data processing system according to Example A3, wherein (a) the display protection module, when executed by the data processing system, causes the anchor to be displayed on the primary display within a frame for the presentation application; and (b) the operation of generating the rendered screen comprises causing content in the rendered screen to align with the frame for the presentation application. Example A5 may also include the features of Example A4.

Example A6 is a data processing system according to Example A1, wherein the display protection module, when executed by the data processing system, enables the data processing system to automatically determine whether at least part of the output screen from the presentation application should receive display protection based on at least one CMR protection policy from the group consisting of (a) a first CMR protection policy that identifies at least one particular type of content to receive CMR protection; and (b) a second CMR protection policy that identifies at least one particular presentation application to receive CMR protection. Example A6 may also include the features of any one or more of Examples A2 through A5.

Example A7 is a data processing system according to Example A1, wherein the display protection module, when executed by the data processing system, enables the data processing system to automatically determine whether at least part of the output screen from the presentation application should receive display protection based on at least one determination from the group consisting of (a) a determination that a user of the data processing system has selected CMR protection, and (b) a determination that the presentation application has requested CMR protection. Example A7 may also include the features of any one or more of Examples A2 through A6.

Example A8 is a data processing system according to Example A1, wherein the display protection module, when executed by the data processing system, enables the data processing system to receiving a request from the presentation application for CMR protection. Also, the determination that at least part of the output screen should receive display protection is based on the request from the presentation application for CMR protection. Example A8 may also include the features of any one or more of Examples A2 through A7.

Example A9 is a data processing system according to Example A1, wherein the operation of automatically causing at least some content from the output screen to be sent to the CMR headset comprises (a) generating a rendered screen which includes content that has been stretched and skewed based on a perspective of a person wearing the CMR headset, relative to the primary display; and (b) sending the rendered screen to the CMR headset. Example A9 may also include the features of any one or more of Examples A2 through A8.

Example B1 is an apparatus to enable protection of digital content using CRM. The apparatus comprises a non-transitory machine-readable medium and a display protection module stored in the machine-readable medium. The display protection module, when executed by a data processing system, enables the data processing system to perform operations comprising (a) automatically determining whether at least part of an output screen from a presentation application should receive display protection; (b) in response to a determination that the output screen should not receive display protection, causing at least some content from the output screen to be sent to a primary display of the data processing system; and (c) in response to a determination that at least part of the output screen should receive display protection, automatically causing at least some content from the output screen to be sent to a computer-mediated reality (CMR) headset of the data processing system.

Example B2 is an apparatus according to Example B1, wherein the operation of automatically causing at least some content from the output screen to be sent to the CMR headset comprises (a) generating a rendered screen which includes content that has been adjusted to align with the primary display from a perspective of a person wearing the CMR headset; and (b) sending the rendered screen to the CMR headset.

Example B3 is an apparatus according to Example B2, wherein the operation of generating the rendered screen comprises automatically using an anchor displayed on the primary display to determine the perspective of the person wearing the CMR headset.

Example B4 is an apparatus according to Example B3, wherein the display protection module, when executed by the data processing system, enables the data processing system to perform further operations comprising (a) automatically adding the anchor to an unprotected screen, and (b) sending the unprotected screen to the primary display.

Example B5 is an apparatus according to Example B3, wherein (a) the display protection module, when executed by the data processing system, causes the anchor to be displayed on the primary display within a frame for the presentation application; and (b) the operation of generating the rendered screen comprises causing content in the rendered screen to align with the frame for the presentation application. Example B5 may also include the features of Example B4.

Example B6 is an apparatus according to Example B 1, wherein the display protection module, when executed by the data processing system, enables the data processing system to automatically determine whether at least part of the output screen from the presentation application should receive display protection based on at least one CMR protection policy from the group consisting of (a) a first CMR protection policy that identifies at least one particular type of content to receive CMR protection, and (b) a second CMR protection policy that identifies at least one particular presentation application to receive CMR protection. Example B6 may also include the features of any one or more of Examples B2 through B5.

Example B7 is an apparatus according to Example B 1, wherein the display protection module, when executed by the data processing system, enables the data processing system to automatically determine whether at least part of the output screen from the presentation application should receive display protection based on at least one determination from the group consisting of (a) a determination that a user of the data processing system has selected CMR protection, and (b) a determination that the presentation application has requested CMR protection. Example B7 may also include the features of any one or more of Examples B2 through B6.

Example B8 is an apparatus according to Example B 1, wherein the display protection module, when executed by the data processing system, enables the data processing system to receiving a request from the presentation application for CMR protection. Also, the determination that at least part of the output screen should receive display protection is based on the request from the presentation application for CMR protection. Example B8 may also include the features of any one or more of Examples B2 through B7.

Example B9 is an apparatus according to Example B1, wherein the operation of automatically causing at least some content from the output screen to be sent to the CMR headset comprises (a) generating a rendered screen which includes content that has been stretched and skewed based on a perspective of a person wearing the CMR headset, relative to the primary display, and (b) sending the rendered screen to the CMR headset. Example B9 may also include the features of any one or more of Examples B2 through B8.

Example C1 is a method for using CMR to protect digital content. The method comprises (a) in a data processing system with a presentation application, a primary display, and a computer-mediated reality (CMR) headset, automatically determining whether at least part of an output screen from the presentation application should receive display protection; (b) in response to a determination that the output screen should not receive display protection, causing at least some content from the output screen to be sent to the primary display; and (c) in response to a determination that at least part of the output screen should receive display protection, automatically causing at least some content from the output screen to be sent to the CMR headset.

Example C2 is a method according to Example C1, wherein the operation of automatically causing at least some content from the output screen to be sent to the CMR headset comprises (a) generating a rendered screen which includes content that has been adjusted to align with the primary display from a perspective of a person wearing the CMR headset, and (b) sending the rendered screen to the CMR headset.

Example C3 is a method according to Example C2, wherein the operation of generating the rendered screen comprises automatically using an anchor displayed on the primary display to determine the perspective of the person wearing the CMR headset.

Example C4 is a method according to Example C3, further comprising (a) automatically adding the anchor to an unprotected screen; and (b) causing the unprotected screen to be displayed on the primary display.

Example C5 is a method according to Example C3, wherein (a) the anchor is displayed on the primary display within a frame for the presentation application; and (b) the operation of generating the rendered screen comprises causing content in the rendered screen to align with the frame for the presentation application. Example C5 may also include the features of Example C4.

Example C6 is a method according to Example C1, wherein the data processing system automatically determines whether at least part of the output screen from the presentation application should receive display protection based on at least one CMR protection policy from the group consisting of (a) a first CMR protection policy that identifies at least one particular type of content to receive CMR protection; and (b) a second CMR protection policy that identifies at least one particular presentation application to receive CMR protection. Example C6 may also include the features of any one or more of Examples C2 through C5.

Example C7 is a method according to Example C1, wherein the data processing system automatically determines whether at least part of the output screen from the presentation application should receive display protection based on at least one determination from the group consisting of (a) a determination that a user of the data processing system has selected CMR protection, and (b) a determination that the presentation application has requested CMR protection. Example C7 may also include the features of any one or more of Examples C2 through C6.

Example C8 is a method according to Example C1, further comprising receiving a request from the presentation application for CMR protection. Also, the determination that at least part of the output screen should receive display protection is based on the request from the presentation application for CMR protection. Example C8 may also include the features of any one or more of Examples C2 through C7.

Example C9 is a method according to Example C1, wherein the operation of automatically causing at least some content from the output screen to be sent to the CMR headset comprises (a) generating a rendered screen which includes content that has been stretched and skewed based on a perspective of a person wearing the CMR headset, relative to the primary display; and (b) sending the rendered screen to the CMR headset. Example C9 may also include the features of any one or more of Examples C2 through C8.

Example D is at least one machine-readable medium comprising computer instructions to enable protection of digital content using CMR. The computer instructions, in response to being executed in a device, enable the device to perform a method according to any of Examples C1 through C9.

Example E is a data processing system with technology for protecting digital content using CMR. The data processing system comprising a processing element, at least one machine-readable medium responsive to the processing element, and computer instructions stored at least partially in the at least one machine-accessible medium. The computer instructions, in response to being executed, enable the data processing system to perform a method according to any of Examples C1 through C9.

Example F is a data processing system with technology for protecting digital content using CMR. The data processing system comprises means for performing the method of any one of Examples C1 through C9.

What is claimed is:

1. A data processing system with technology for protecting digital content using computer-mediated reality, the data processing system comprising:
a processor;
first and second video ports responsive to the processor;
a non-transitory machine-readable medium responsive to the processor; and
a display protection module stored in the machine-readable medium, wherein the display protection module, when executed by the data processing system, enables the data processing system to perform operations comprising:
automatically determining whether at least part of an output screen from a presentation application should receive display protection;
in response to a determination that the output screen should not receive display protection, causing at least some content from the output screen to be sent to a primary display via the first video port; and
in response to a determination that at least part of the output screen should receive display protection, automatically causing at least some content from the output screen to be sent to a computer-mediated reality (CMR) headset via the second video port.

2. A data processing system according to claim 1, wherein the operation of automatically causing at least some content from the output screen to be sent to the CMR headset comprises:
generating a rendered screen which includes content that has been adjusted to align with the primary display from a perspective of a person wearing the CMR headset; and
sending the rendered screen to the CMR headset.

3. A data processing system according to claim 2, wherein the operation of generating the rendered screen comprises:
automatically using an anchor displayed on the primary display to determine the perspective of the person wearing the CMR headset.

4. A data processing system according to claim 3, wherein the display protection module, when executed by the data processing system, enables the data processing system to perform further operations comprising:
automatically adding the anchor to an unprotected screen; and
sending the unprotected screen to the primary display.

5. A data processing system according to claim 3, wherein:
the display protection module, when executed by the data processing system, causes the anchor to be displayed on the primary display within a frame for the presentation application; and
the operation of generating the rendered screen comprises causing content in the rendered screen to align with the frame for the presentation application.

6. A data processing system according to claim 1, wherein the display protection module, when executed by the data processing system, enables the data processing system to automatically determine whether at least part of the output screen from the presentation application should receive display protection based on at least one CMR protection policy from the group consisting of:
a first CMR protection policy that identifies at least one particular type of content to receive CMR protection; and
a second CMR protection policy that identifies at least one particular presentation application to receive CMR protection.

7. A data processing system according to claim 1, wherein the display protection module, when executed by the data processing system, enables the data processing system to automatically determine whether at least part of the output screen from the presentation application should receive display protection based on at least one determination from the group consisting of:
a determination that a user of the data processing system has selected CMR protection; and
a determination that the presentation application has requested CMR protection.

8. A data processing system according to claim 1, wherein:
the display protection module, when executed by the data processing system, enables the data processing system to receiving a request from the presentation application for CMR protection; and
the determination that at least part of the output screen should receive display protection is based on the request from the presentation application for CMR protection.

9. A data processing system according to claim 1, wherein the operation of automatically causing at least some content from the output screen to be sent to the CMR headset comprises:
generating a rendered screen which includes content that has been stretched and skewed based on a perspective of a person wearing the CMR headset, relative to the primary display; and
sending the rendered screen to the CMR headset.

10. An apparatus to enable protection of digital content using computer-mediated reality, the apparatus comprising:
a non-transitory machine-readable medium; and
a display protection module stored in the machine-readable medium, wherein the display protection module, when executed by a data processing system, enables the data processing system to perform operations comprising:
automatically determining whether at least part of an output screen from a presentation application should receive display protection;
in response to a determination that the output screen should not receive display protection, causing at least some content from the output screen to be sent to a primary display of the data processing system; and
in response to a determination that at least part of the output screen should receive display protection, automatically causing at least some content from the output screen to be sent to a computer-mediated reality (CMR) headset of the data processing system.

11. An apparatus according to claim 10, wherein the operation of automatically causing at least some content from the output screen to be sent to the CMR headset comprises:
generating a rendered screen which includes content that has been adjusted to align with the primary display from a perspective of a person wearing the CMR headset; and
sending the rendered screen to the CMR headset.

12. An apparatus according to claim 11, wherein the operation of generating the rendered screen comprises:
automatically using an anchor displayed on the primary display to determine the perspective of the person wearing the CMR headset.

13. An apparatus according to claim 12, wherein the display protection module, when executed by the data processing system, enables the data processing system to perform further operations comprising:
automatically adding the anchor to an unprotected screen; and
sending the unprotected screen to the primary display.

14. An apparatus according to claim 12, wherein:
the display protection module, when executed by the data processing system, causes the anchor to be displayed on the primary display within a frame for the presentation application; and
the operation of generating the rendered screen comprises causing content in the rendered screen to align with the frame for the presentation application.

15. An apparatus according to claim 10, wherein the display protection module, when executed by the data processing system, enables the data processing system to automatically determine whether at least part of the output screen from the presentation application should receive display protection based on at least one CMR protection policy from the group consisting of:
a first CMR protection policy that identifies at least one particular type of content to receive CMR protection; and
a second CMR protection policy that identifies at least one particular presentation application to receive CMR protection.

16. An apparatus according to claim 10, wherein the display protection module, when executed by the data processing system, enables the data processing system to automatically determine whether at least part of the output screen from the presentation application should receive display protection based on at least one determination from the group consisting of:
a determination that a user of the data processing system has selected CMR protection; and
a determination that the presentation application has requested CMR protection.

17. An apparatus according to claim 10, wherein:
the display protection module, when executed by the data processing system, enables the data processing system to receiving a request from the presentation application for CMR protection; and
the determination that at least part of the output screen should receive display protection is based on the request from the presentation application for CMR protection.

18. An apparatus according to claim 10, wherein the operation of automatically causing at least some content from the output screen to be sent to the CMR headset comprises:
generating a rendered screen which includes content that has been stretched and skewed based on a perspective of a person wearing the CMR headset, relative to the primary display; and
sending the rendered screen to the CMR headset.

19. A method for using computer-mediated reality to protect digital content, the method comprising:
in a data processing system with a presentation application, a primary display, and a computer-mediated reality (CMR) headset, automatically determining whether at least part of an output screen from the presentation application should receive display protection;
in response to a determination that the output screen should not receive display protection, causing at least some content from the output screen to be sent to the primary display; and
in response to a determination that at least part of the output screen should receive display protection, automatically causing at least some content from the output screen to be sent to the CMR headset.

20. A method according to claim 19, wherein the operation of automatically causing at least some content from the output screen to be sent to the CMR headset comprises:
generating a rendered screen which includes content that has been adjusted to align with the primary display from a perspective of a person wearing the CMR headset; and
sending the rendered screen to the CMR headset.

21. A method according to claim 20, wherein the operation of generating the rendered screen comprises:
automatically using an anchor displayed on the primary display to determine the perspective of the person wearing the CMR headset.

22. A method according to claim 21, further comprising:
automatically adding the anchor to an unprotected screen; and
causing the unprotected screen to be displayed on the primary display.

23. A method according to claim 21, wherein:
the anchor is displayed on the primary display within a frame for the presentation application; and
the operation of generating the rendered screen comprises causing content in the rendered screen to align with the frame for the presentation application.

24. A method according to claim 19, wherein the data processing system automatically determines whether at least part of the output screen from the presentation application should receive display protection based on at least one CMR protection policy from the group consisting of:
a first CMR protection policy that identifies at least one particular type of content to receive CMR protection; and
a second CMR protection policy that identifies at least one particular presentation application to receive CMR protection.

25. A method according to claim 19, wherein the data processing system automatically determines whether at least part of the output screen from the presentation application should receive display protection based on at least one determination from the group consisting of:
a determination that a user of the data processing system has selected CMR protection; and
a determination that the presentation application has requested CMR protection.
